(19) United States
(12) Patent Application Publication
(10) Pub. No.: US 2024/0185641 A1
(43) Pub. Date: Jun. 6, 2024

(54) FINGERPRINT INFORMATION PROCESSING APPARATUS, FINGERPRINT INFORMATION PROCESSING METHOD, AND NON-TRANSITORY STORAGE MEDIUM

(71) Applicant: NEC Corporation, Minato-ku, Tokyo (JP)

(72) Inventor: Eri KUNIEDA, Tokyo (JP)

(73) Assignee: NEC Corporation, Minato-ku, Tokyo (JP)

(21) Appl. No.: 18/287,679

(22) PCT Filed: Apr. 30, 2021
(86) PCT No.: PCT/JP2021/017223

§ 371 Date: Oct. 20, 2023

(51) Int. Cl. G06V 40/70; G06V 40/12

(52) U.S. Cl. CPC G06V 40/70; G06V 40/1335; G06V 40/1365

(57) ABSTRACT

The present invention provides a fingerprint information processing apparatus (10) including an acquisition unit (11) that acquires a plurality of pieces of partial fingerprint information, and attribute information of a person from whom each of a plurality of pieces of the partial fingerprint information is derived, and an information generation unit (12) that generates first information indicating a likelihood that a plurality of pieces of the partial fingerprint information are derived from a same person, by using the partial fingerprint information and the attribute information.

### TECHNICAL FIELD

The present invention relates to a fingerprint information processing apparatus, a fingerprint information processing method, and a program.

### BACKGROUND ART

Many of fingerprints left at a site of an incident or the like are partial fingerprints. In fingerprint collation processing using a partial fingerprint as described above, collation accuracy becomes insufficient. In view of the above, Patent Document 1 discloses a technique for combining partial fingerprints with each other.

Patent Document 1 discloses a fingerprint combining apparatus including a unit that searches for a partial fingerprint in which a content of extracted keypoint data is similar to each other, and a unit that generates image data on a new fingerprint by combining pieces of image data on the partial fingerprint in which the content of the extracted keypoint data is sufficiently similar to each other.

### RELATED DOCUMENT

### Patent Document

Patent Document 1: Japanese Patent Application Publication No. H7-306941

### DISCLOSURE OF THE INVENTION

### Technical Problem

A keypoint to be extracted from a partial fingerprint may become quantitatively insufficient. Further, a portion including a fingerprint, and a portion lacking a fingerprint may be different from each other for each partial fingerprint. Therefore, even when a fingerprint is a partial fingerprint derived from a same person, a degree of similarity based on a content of extracted keypoint data may be lowered. For a reason as described above, in a case of the technique described in Patent Document 1, there has been a problem that a probability with which combination of partial fingerprints to be combined with each other can be searched for is low.

An object of the present invention is to provide a new technique for searching for a partial fingerprint derived from a same person.

### Solution to Problem

The present invention provides a fingerprint information processing apparatus including:
an acquisition unit that acquires a plurality of pieces of partial fingerprint information, and attribute information of a person from whom each of a plurality of pieces of the partial fingerprint information is derived; and
an information generation unit that generates first information indicating a likelihood that a plurality of pieces of the partial fingerprint information are derived from a same person, by using the partial fingerprint information and the attribute information.

Further, the present invention provides a fingerprint information processing method including,
by a computer:
   an acquisition step of acquiring a plurality of pieces of partial fingerprint information, and attribute information of a person from whom each of a plurality of pieces of the partial fingerprint information is derived; and
   an information generation step of generating first information indicating a likelihood that a plurality of pieces of the partial fingerprint information are derived from a same person, by using the partial fingerprint information and the attribute information.

Further, the present invention provides a program causing a computer to function as:
an acquisition unit that acquires a plurality of pieces of partial fingerprint information, and attribute information of a person from whom each of a plurality of pieces of the partial fingerprint information is derived; and
an information generation unit that generates first information indicating a likelihood that a plurality of pieces of the partial fingerprint information are derived from a same person, by using the partial fingerprint information and the attribute information.

### Advantageous Effects of Invention

The present invention achieves a new technique for searching for a partial fingerprint derived from a same person.

### BRIEF DESCRIPTION OF THE DRAWINGS

FIG. 1 It is a diagram illustrating an overview of processing of a fingerprint information processing apparatus according to a present example embodiment.

FIG. 2 It is a diagram illustrating one example of a hardware configuration of the fingerprint information processing apparatus according to the present example embodiment.

FIG. 3 It is one example of a functional block diagram of the fingerprint information processing apparatus according to the present example embodiment.

FIG. 4 It is one example of a functional block diagram of the fingerprint information processing apparatus according to the present example embodiment.

FIG. 5 It is a diagram schematically illustrating one example of information to be processed by the fingerprint information processing apparatus according to the present example embodiment.

FIG. 6 It is a flowchart illustrating one example of a flow of processing of the fingerprint information processing apparatus according to the present example embodiment.

FIG. 7 It is a flowchart illustrating one example of a flow of processing of the fingerprint information processing apparatus according to the present example embodiment.

FIG. 8 It is a diagram schematically illustrating one example of information to be output from the fingerprint information processing apparatus according to the present example embodiment.

FIG. 9 It is a diagram schematically illustrating one example of information to be output from the fingerprint information processing apparatus according to the present example embodiment.

FIG. 10 It is a flowchart illustrating one example of a flow of processing of the fingerprint information processing apparatus according to the present example embodiment.

FIG. 11 It is a flowchart illustrating one example of a flow of processing of the fingerprint information processing apparatus according to the present example embodiment.

FIG. 12 It is a diagram schematically illustrating one example of information to be output from the fingerprint information processing apparatus according to the present example embodiment.

FIG. 13 It is a flowchart illustrating one example of a flow of processing of the fingerprint information processing apparatus according to the present example embodiment.

FIG. 14 It is a diagram illustrating an overview of processing of the fingerprint information processing apparatus according to the present example embodiment.

FIG. 15 It is one example of a functional block diagram of the fingerprint information processing apparatus according to the present example embodiment.

FIG. 16 It is a diagram schematically illustrating one example of information to be processed by the fingerprint information processing apparatus according to the present example embodiment.

FIG. 17 It is a flowchart illustrating one example of a flow of processing of the fingerprint information processing apparatus according to the present example embodiment.

FIG. 18 It is one example of a functional block diagram of the fingerprint information processing apparatus according to the present example embodiment.

FIG. 19 It is a flowchart illustrating one example of a flow of processing of work utilizing the fingerprint information processing apparatus according to the present example embodiment.

FIG. 20 It is a flowchart illustrating one example of a flow of processing of work utilizing the fingerprint information processing apparatus according to the present example embodiment.

FIG. 21 It is a flowchart illustrating one example of a flow of processing of work utilizing the fingerprint information processing apparatus according to the present example embodiment.

### DESCRIPTION OF EMBODIMENTS

Hereinafter, example embodiments according to the present invention are described by using the drawings. Note that, in all drawings, a similar constituent element is indicated by a similar reference sign, and description thereof is omitted as necessary.

### Description on Terms

First, some of terms to be used in a present example embodiment are described.

“Fingerprint information”: Fingerprint information is information relating to a fingerprint. Fingerprint information includes at least one of image data on a fingerprint, and a feature value of the fingerprint extracted from the image data on the fingerprint.

“Feature value of fingerprint”: A feature value of a fingerprint is information indicating a feature of an external appearance of a fingerprint. A feature value of a fingerprint is computed, for example, based on a keypoint extracted from a fingerprint. As a keypoint of a fingerprint, for example, a center point, a branching point, an end point, delta, and the like are exemplified, but the keypoint of the fingerprint is not limited thereto. The center point is a point of center of a fingerprint. The branching point is a point at which a line of a fingerprint is branched into a plurality of lines. The end point is a point at which a line of a fingerprint stops. The delta is a point at which three lines gather from three directions. A feature value indicating a type, a position, and the like of each of a plurality of extracted keypoints is computed, for example, based on a keypoint of a fingerprint as described above.

“Partial fingerprint”: A partial fingerprint is a fingerprint including some keypoints necessary for achieving collation accuracy of a desired level or more in fingerprint collation, and lacking some keypoints. Various patterns are conceived regarding which portion of a fingerprint is included, and which portion of a fingerprint is lacking, and a pattern may differ for each partial fingerprint.

“Partial fingerprint information”: Partial fingerprint information is information relating to a partial fingerprint, and includes at least one of image data on a partial fingerprint, and a feature value of a fingerprint extracted from the image data on the partial fingerprint.

“Complete fingerprint”: A complete fingerprint is a fingerprint including a major part, for example, all of keypoints necessary for achieving collation accuracy of a desired level or more in fingerprint collation.

“Complete fingerprint information”: Complete fingerprint information is information relating to a complete fingerprint, and includes at least one of image data on a complete fingerprint, and a feature value of a fingerprint extracted from the image data on the complete fingerprint.

“Latent inquiry (LI)”: LI is a latent inquiry service. In LI, collation between fingerprint information relating to a fingerprint collected at a site of an incident or the like, and fingerprint information whose identity is known is performed. Fingerprint information whose identity is known is, for example, fingerprint information of a person who committed a certain crime in a past, and was arrested. Fingerprint information whose identity is known is complete fingerprint information.

“Latent/latent inquiry (LLI)”: LLI is a same-offender inquiry service. In LLI, collation between fingerprint information relating to a fingerprint collected at a site of an incident or the like, and fingerprint information whose identity is unknown is performed. Fingerprint information whose identity is unknown is, for example, fingerprint information relating to a fingerprint collected at a site of an unresolved incident that occurred in a past, or the like. A major part of fingerprint information whose identity is unknown is partial fingerprint information.

### First Example Embodiment

### Overview

An overview of a technique according to a present example embodiment is described. In the present example embodiment, a technique for searching for partial fingerprint information derived from a same person is provided. In the present example embodiment, in addition to a degree of similarity between pieces of partial fingerprint information, determination is made as to whether a plurality of pieces of partial fingerprint information are derived from a same person, taking into consideration a degree of similarity between pieces of attribution information of a person from whom each piece of partial fingerprint information is derived.

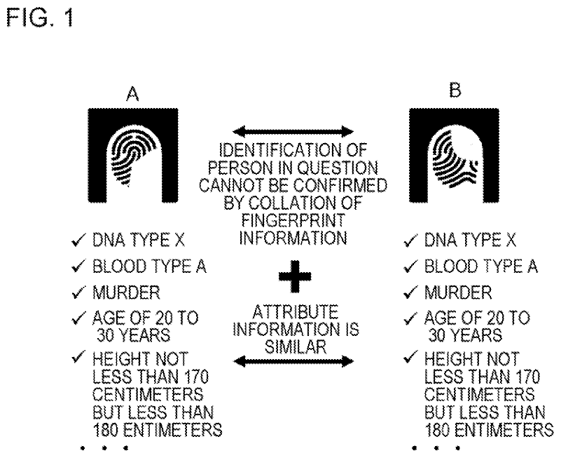

The concept is described by using FIG. 1. FIG. 1 illustrates two pieces of partial fingerprint information A and B derived from a same person. The partial fingerprint information A lacks a lower right portion in the drawing. Then, the partial fingerprint information B lacks an upper right portion in the drawing.

Further, FIG. 1 illustrates attribute information of a person from whom each of the two pieces of partial fingerprint information A and B is derived. In FIG. 1, as one example of attribute information, a DNA type, a blood type, a type of an incident, an estimated age, an estimated height, and the like are illustrated. Attribute information associated with the partial fingerprint information A is generated based on an inspection at an incident site related to an incident where the partial fingerprint information A is collected, testimony of a witness, an analysis of a surveillance camera image, and the like. Further, attribute information associated with the partial fingerprint information B is generated based on an inspection at an incident site related to an incident where the partial fingerprint information B is collected, testimony of a witness, an analysis of a surveillance camera image, and the like.

As described above, the partial fingerprint information A and B are derived from a same person. However, since lacking portions are different from each other, it is not possible to determine that the partial fingerprint information A and B are derived from a same person only by a degree of similarity computed by collation between pieces of partial fingerprint information. However, as illustrated in FIG. 1, attribute information of the partial finger print information A and B is very similar to each other. Therefore, it becomes possible to determine that the partial fingerprint information A and B are derived from a same person by further taking into consideration a degree of similarity computed by collation between pieces of attribute information.

A fingerprint information processing apparatus according to the present example embodiment utilizes a technique according to the present example embodiment as described above. The fingerprint information processing apparatus includes a function of generating first information indicating a likelihood that a plurality of pieces of partial fingerprint information are derived from a same person, by using the partial fingerprint information and attribute information of a person from whom each piece of the partial fingerprint information is derived. Hereinafter, a configuration of the fingerprint information processing apparatus is described in detail.

### “Hardware Configuration”

One example of a hardware configuration of the fingerprint information processing apparatus according to the present example embodiment is described. Each functional unit of the fingerprint information processing apparatus is achieved by any combination of hardware and software, mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Then, it is understood by a person skilled in the art that there are various modification examples as a method and an apparatus for achieving the configuration.

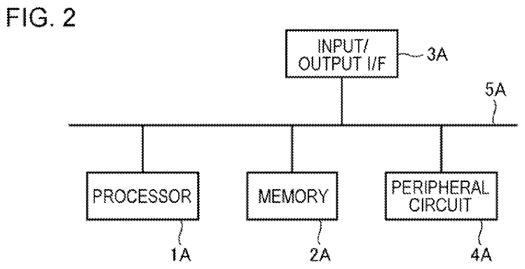

FIG. 2 is a block diagram illustrating the hardware configuration of the fingerprint information processing apparatus. As illustrated in FIG. 2, the fingerprint information processing apparatus includes a processor 1A, a memory 2A, an input/output interface 3A, a peripheral circuit 4A, and a bus 5A. The peripheral circuit 4A includes various modules. The fingerprint information processing apparatus may not include the peripheral circuit 4A. Note that, the fingerprint information processing apparatus may be constituted of one apparatus that is physically and logically integrated, or may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on an arithmetic operation result of each module.

### “Functional Configuration”

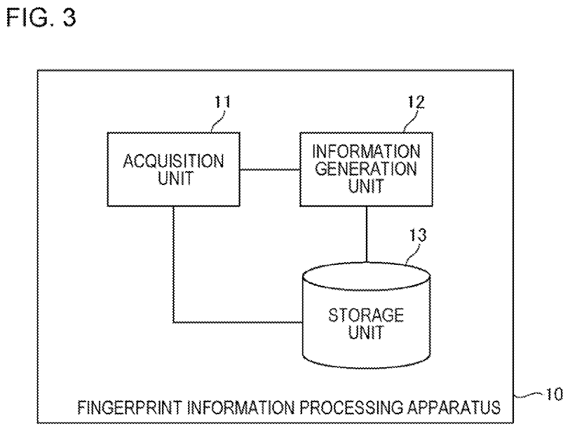

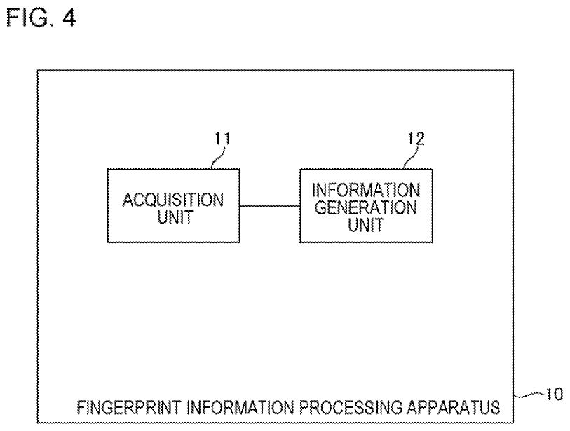

A functional configuration of the fingerprint information processing apparatus is described. FIG. 3 illustrates one example of a functional block diagram of a fingerprint information processing apparatus 10. As illustrated in FIG. 3, the fingerprint information processing apparatus 10 includes an acquisition unit 11, an information generation unit 12, and a storage unit 13. Note that, as illustrated in a functional block diagram in FIG. 4, the fingerprint information processing apparatus 10 may not include the storage unit 13. In this case, an external apparatus communicably connected to the fingerprint information processing apparatus 10 includes the storage unit 13.

The acquisition unit 11 acquires a plurality of pieces of partial fingerprint information, and attribute information of a person from whom each of the plurality of pieces of partial fingerprint information is derived. By the information generation unit 12 described in the following, a plurality of pieces of partial fingerprint information acquired by the acquisition unit 11 are collated with each other, and a plurality of pieces of attribute information acquired by the acquisition unit 11 are collated with each other.

Partial fingerprint information is information relating to a partial fingerprint as described above, and includes at least one of image data on a partial fingerprint, and a feature value of a fingerprint extracted from the image data on the partial fingerprint. Partial fingerprint information is generated by photographing a partial fingerprint left at an incident site or the like, or by analyzing a photographed image thereof.

Attribute information is information relating to a person from whom each of a plurality of pieces of partial fingerprint information is derived. Attribute information is generated based on an inspection at an incident site, testimony of a witness, an analysis of a surveillance camera image, and the like.

Attribute information can indicate, for example, at least one of a physical feature and a behavioral feature. As the physical feature, an estimated height, an estimated weight, a physique, and the like are exemplified, but the physical feature is not limited thereto. As the behavioral feature, a content of a crime, a way of committing a crime, a type of a used weapon, a habit, and the like are exemplified, but the behavioral feature is not limited thereto.

In addition, attribute information can indicate at least one of information relating to a place where partial fingerprint information is collected, information detected at a place where partial fingerprint information is collected, and information relating to an incident where partial fingerprint information is collected. As the information relating to a place where partial fingerprint information is collected, a type of a facility such as a hospital, a station, and a school, information indicating a crime area such as a name of a prefecture, and an address, and the like are exemplified, but the information is not limited thereto. As the information detected at a place where partial fingerprint information is collected, information relating to a left article, a way of committing a crime, and the like are exemplified, but the information is not limited thereto. As the information relating to an incident where partial fingerprint information is collected, a content of a crime, a date and time of a crime, a way of committing a crime, information on a victim, and the like are exemplified, but the information is not limited thereto.

Note that, attribute information may indicate, for example, at least one of a blood type, a DNA type, gender, an age group, and a height.

Herein, one example of processing of acquiring a plurality of pieces of fingerprint information and a plurality of pieces of attribute information by the acquisition unit 11 is described.

### First Acquisition Example

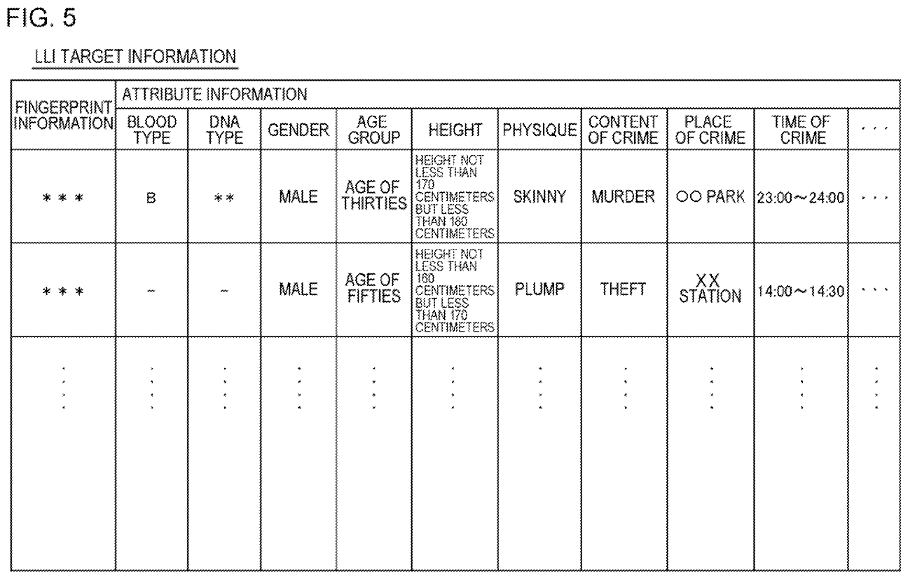

First, the storage unit 13 stores LLI target information as illustrated in FIG. 5. LLI target information is information subjected to LLI processing. LLI target information includes fingerprint information relating to a fingerprint being collected at a site of an unresolved incident that has occurred in a past or the like, and whose identity is unknown, and attribute information. A major part of fingerprint information included in LLI target information is partial fingerprint information. In FIG. 5, as one example of attribute information, a blood type, a DNA type, gender, an age group, a height, a physique, a content of a crime, a place of a crime, and a time of a crime are illustrated. Note that, a type of piece of attribute information acquirable for each incident may differ. Therefore, a type of piece of attribute information registered in association with each piece of fingerprint information may also differ from each other.

The acquisition unit 11 acquires, from among pieces of LLI target information stored in the storage unit 13, a plurality of pieces of fingerprint information and a plurality of pieces of attribute information, based on a predetermined rule. For example, the acquisition unit 11 acquires, from among pieces of LLI target information stored in the storage unit 13, two pieces of fingerprint information item, based on a predetermined rule, and also acquires attribute information associated with each of the two pieces of fingerprint information.

### Second Acquisition Example

An operator inputs, to the fingerprint information processing apparatus 10, partial fingerprint information relating to a partial fingerprint newly collected at an incident site or the like, and attribute information. Then, the acquisition unit 11 acquires the partial fingerprint information and the attribute information. Further, the acquisition unit 11 acquires, from among pieces of LLI target information stored in the storage unit 13, partial fingerprint information and attribute information serving as a collation target of the partial fingerprint information and the attribute information.

Referring back to FIGS. 3 and 4, the information generation unit 12 generates the first information indicating a likelihood that a plurality of pieces of partial fingerprint information are derived from a same person, by using the plurality of pieces of partial fingerprint information and a plurality of pieces of attribute information acquired by the acquisition unit 11. For example, the information generation unit 12 performs collation between a plurality of pieces of partial fingerprint information acquired by the acquisition unit 11, collation between a plurality of pieces of attribute information acquired by the acquisition unit 11, and the like. Then, the information generation unit 12 generates the first information, based on these collation results.

The information generation unit 12 generates the first information, based on a degree of similarity between a plurality of pieces of partial fingerprint information, and a degree of similarity between a plurality of pieces of attribute information. The higher a degree of similarity between a plurality of pieces of partial fingerprint information, the higher a likelihood that the plurality of pieces of partial fingerprint information are derived from a same person. Further, the higher a degree of similarity between a plurality of pieces of attribute information, the higher a likelihood that the plurality of pieces of partial fingerprint information are derived from a same person. As far as a relationship as described above can be secured, a computation method of the first information by the information generation unit 12 can be achieved by adopting any available technique. Note that, a specific example of a computation method of the first information by the information generation unit 12 is described in the following example embodiment.

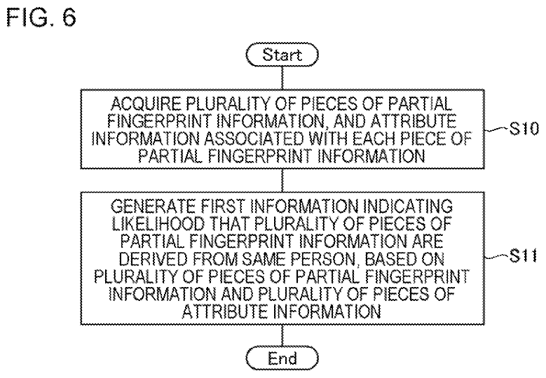

Next, one example of a flow of processing of the fingerprint information processing apparatus 10 is described by using a flowchart in FIG. 6.

First, the acquisition unit 11 acquires a plurality of pieces of partial fingerprint information, and attribute information of a person from whom each of the plurality of pieces of partial fingerprint information is derived (S10). Next, the information generation unit 12 generates the first information indicating a likelihood that the plurality of pieces of partial fingerprint information acquired in S10 are derived from a same person, by using the partial fingerprint information and the attribute information acquired in S10 (S11).

Note that, although not illustrated, the fingerprint information processing apparatus 10 can provide an operator with the first information generated in S11 in association with the plurality of pieces of partial fingerprint information acquired in S10. Information provision to an operator can be achieved by utilizing any means such as an output of information via an output apparatus such as a display, a speaker, or a printer, transmission of information by an electronic mail, or information provision on a screen after login in a predetermined application or a predetermined system.

### Advantageous Effect

In the fingerprint information processing apparatus 10 according to the present example embodiment described above, it is possible to generate the first information indicating a likelihood that a plurality of pieces of partial fingerprint information are derived from a same person, by using not only partial fingerprint information but also attribute information of a person from whom each piece of partial fingerprint information is derived. Then, an operator can determine whether the plurality of pieces of partial fingerprint information are derived from a same person, based on the first information as described above. By further utilizing attribution information, in addition to partial fingerprint information, it becomes possible to determine that a plurality of pieces of partial fingerprint information that are not capable of determining to be derived from a same person only by the partial fingerprint information are derived from a same person.

### Second Example Embodiment

In a present example embodiment, a generation means of first information indicating a likelihood that a plurality of pieces of partial fingerprint information are derived from a same person is embodied.

An information generation unit 12 computes a fingerprint score indicating a degree of similarity between a plurality of pieces of partial fingerprint information acquired by an acquisition unit 11. Further, the information generation unit 12 computes an attribute score indicating a degree of similarity between a plurality of pieces of attribute information acquired by the acquisition unit 11. Then, the information generation unit 12 generates the first information, based on the computed fingerprint score and the computed attribute score. The first information according to the present example embodiment is a “fingerprint score”, and an “integrated collation score” to be computed based on the fingerprint score and an attribute score. Hereinafter, a computation method of a fingerprint score, an attribute score, and an integrated collation score is described.

### —Computation Method of Fingerprint Score—

The information generation unit 12 computes a fingerprint score indicating a degree of similarity between a plurality of pieces of partial fingerprint information by collating the plurality of pieces of partial fingerprint information with each other. In the present example embodiment, it is assumed that, as a plurality of pieces of partial fingerprint information are similar to each other, a value of a fingerprint score increases, but may be vice versa.

There are various collation methods of partial fingerprint information, and computation methods of a fingerprint score, based on a collation result, and any existing technique can be adopted. For example, the information generation unit 12 may compute a fingerprint score by utilizing a means disclosed in Patent Document 1. In addition, the information generation unit 12 may compute a fingerprint score by utilizing an existing fingerprint collation technique. In addition, the information generation unit 12 may extract, from among a plurality of keypoints indicated by mutual partial fingerprint information, a keypoint where each of a position and a type coincides with each other, and compute a fingerprint score, based on the number of keypoints where each of an extracted position and an extracted type coincides with each other.

### —Computation Method of Attribute Score—

The information generation unit 12 computes an attribute score indicating a degree of similarity between a plurality of pieces of attribute information by collating the plurality of pieces of attribute information with each other. In the present example embodiment, it is assumed that, as a plurality of pieces of attribute information are similar to each other, a value of an attribute score increases, but may be vice versa.

There are various collation methods of attribute information, and computation methods of an attribute score, based on a collation result, and any existing technique can be adopted.

For example, as described above, attribute information is a group of items of a plurality of types, such as a blood type, a DNA type, gender, an age group, a height, and a content of a crime. In view of the above, the information generation unit 12 may collate attribute information for each item, and compute a collation score for each item. Then, the information generation unit 12 may compute an attribute score by integrating a collation score for each item. As integration of a collation score for each item, a method of adding up a collation score for each item, and the like are exemplified, but the integration is not limited thereto.

Computation of a collation score for each item may be performed based on whether a content coincides with each other. In this case, the information generation unit 12 determines whether a content coincides with each other for each item. Then, the information generation unit 12 computes a collation score for each item, based on a predetermined criterion such as, for example, in a case where a content coincides with each other, P point, and in a case where a content does not coincide with each other, 0 point. Note that, a value of P is a predetermined collation score to be set for each item, and the collation score may differ for each item. For example, a value according to a degree of importance may be determined in advance such that a collation score in a case where a blood type coincides with each other is 500 points, a collation score in a case where a DNA type coincides with each other is 1000 points, and a collation score in a case where gender coincides with each other is 100 points.

Further, computation of a collation score for each item may be computed based on a degree of similarity of a content. In this case, a collation score according to a degree of similarity of a content is defined in advance. For example, since a content of a crime “murder”, and a content of a crime “injury” are relatively similar to each other, a relatively high collation score such as a collation score of 200 points may be defined. Then, since a content of a crime “murder”, and a content of a crime “theft” are not so similar to each other, a relatively low collation score such as a collation score of 50 points may be defined. Herein, a case where an item is a content of a crime has been described as an example, but a similar method can be adopted also regarding other items such as an age group, and a height. In a case of an age group, a height, and the like, a degree of similarity can be defined based on a difference thereof.

### —Computation Method of Integrated Collation Score—

The information generation unit 12 computes an integrated collation score, based on a fingerprint score and an attribute score. There are various contents regarding a computation equation of computing an integrated collation score, but, for example, a method of adding up a fingerprint score and an attribute score may be available. In addition, the computation equation may be the one of adding up a value acquired by multiplying a predetermined weight coefficient by a fingerprint score, and a value acquired by multiplying a predetermined weight coefficient by an attribute score.

Next, one example of a flow of processing of a fingerprint information processing apparatus 10 is described by using a flowchart. The fingerprint information processing apparatus 10 can perform at least one of first to eighth processing examples described below. In the first to fourth processing examples, the acquisition unit 11 performs the second acquisition example described in the first example embodiment. Then, in the fifth to eighth processing examples, the acquisition unit 11 performs the first acquisition example described in the first example embodiment.

### First Processing Example

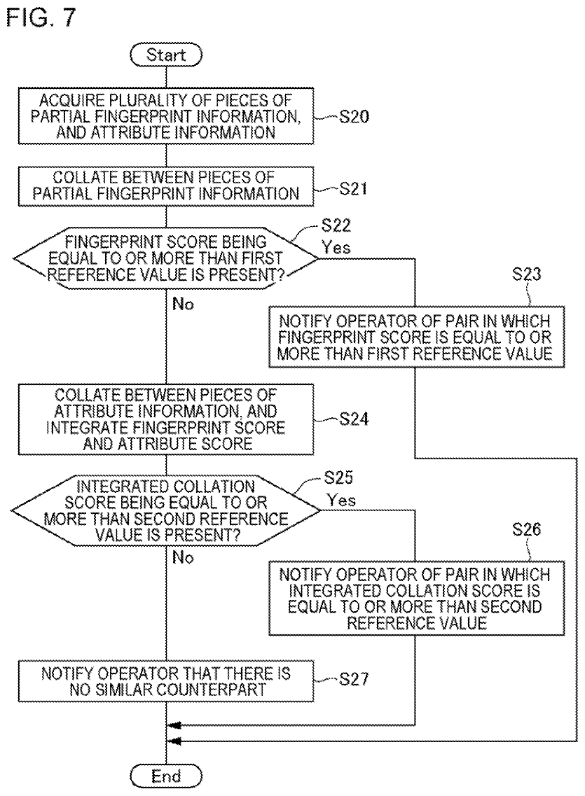

The first processing example is described by using a flowchart in FIG. 7.

In S20, the acquisition unit 11 acquires a plurality of pieces of partial fingerprint information and attribute information. First, partial fingerprint information and attribute information newly collected in association with a new incident are input to the fingerprint information processing apparatus 10. Hereinafter, partial fingerprint information and attribute information newly collected in association with a new incident are referred to as “new partial fingerprint information” and “new attribute information”. For example, an operator may input new partial fingerprint information and new attribute information to the fingerprint information processing apparatus 10. In addition, an external apparatus different from the fingerprint information processing apparatus 10 may input, to the fingerprint information processing apparatus 10, new partial fingerprint information and new attribute information stored in a storage apparatus accessible from an external apparatus, based on an operator's operation, or according to an instruction of a predetermined program. The acquisition unit 11 acquires the input new partial fingerprint information and the input new attribute information.

Further, the acquisition unit 11 acquires, in order from among pieces of LLI target information stored in a storage unit 13, partial fingerprint information and attribute information to be collated with the above-described new partial fingerprint information and the above-described new attribute information. Hereinafter, partial fingerprint information and attribute information to be collated with the new partial fingerprint information and the new attribute information are referred to as “collation target partial fingerprint information” and “collation target attribute information”.

In S21, the information generation unit 12 collates the new partial fingerprint information acquired in S20 with collation target partial fingerprint information, and computes a fingerprint score.

The fingerprint information processing apparatus 10 repeats selection of collation target partial fingerprint information and computation of a fingerprint score until all pieces of LLI target information are selected as collation target partial fingerprint information, and a fingerprint score is computed for each pair of all pieces of collation target partial fingerprint information and new partial fingerprint information. Then, after a fingerprint score is computed for each pair of all pieces of collation target partial fingerprint information and new partial fingerprint information, the processing proceeds to S22.

In S22, the fingerprint information processing apparatus 10 determines whether a pair in which a fingerprint score becomes equal to or more than a first reference value is present. The first reference value is a threshold value for determining whether a plurality of pieces of partial fingerprint information are derived from a same person, based on a fingerprint score. In a case where a pair in which a fingerprint score becomes equal to or more than the first reference value is present (Yes in S22), the processing proceeds to S23. In a case where a pair in which a fingerprint score becomes equal to or more than the first reference value is not present (No in S22), the processing proceeds to S24.

In S23, the fingerprint information processing apparatus 10 notifies an operator of a pair in which a fingerprint score is equal to or more than the first reference value. One of the pair is new partial fingerprint information, and the other of the pair is collation target partial fingerprint information. Notification to an operator is achieved via any output apparatus such as a display, a projection apparatus, a printer, or a mailer.

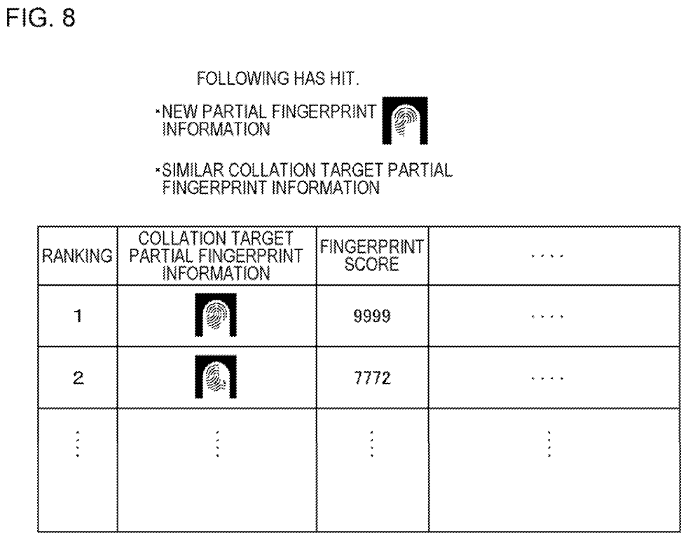

For example, a screen as illustrated in FIG. 8 may be displayed. In an illustrated example, a pair in which a fingerprint score is equal to or more than the first reference value is indicated, and also a fingerprint score is indicated for each pair. Note that, as illustrated in FIG. 8, in a case where a plurality of pairs in which a fingerprint score is equal to or more than the first reference value are present, ranking according to the fingerprint score may be performed, and the pairs may be displayed in order of ranking. An operator can determine whether new partial fingerprint information and collation target partial fingerprint information are to be combined or the like, based on a notification content.

Referring back to FIG. 7, in S24, the information generation unit 12 collates the new attribute information acquired in S20 with collation target attribute information, and computes an attribute score. Then, the information generation unit 12 integrates the computed attribute score, and the fingerprint score computed in S21, and computes an integrated collation score.

The fingerprint information processing apparatus 10 repeats the above-described processing until an integrated collation score is computed for each pair of all pieces of LLI target information, and new partial fingerprint information and new attribute information. Then, after an integrated collation score is computed for each pair of all pieces of LLI target information, and new partial fingerprint information and new attribute information, the processing proceeds to S25.

In S25, the fingerprint information processing apparatus 10 determines whether a pair in which an integrated collation score becomes equal to or more than a second reference value is present. The second reference value is a threshold value for determining whether a plurality of pieces of partial fingerprint information are derived from a same person, based on an integrated collation score. In a case where a pair in which an integrated collation score becomes equal to or more than the second reference value is present (Yes in S25), the processing proceeds to S26. In a case where a pair in which an integrated collation score becomes equal to or more than the second reference value is not present (No in S25), the processing proceeds to S27.

In S26, the fingerprint information processing apparatus 10 notifies an operator of a pair in which an integrated collation score is equal to or more than the second reference value. One of the pair is new partial fingerprint information, and the other of the pair is collation target partial fingerprint information. Notification to an operator is achieved via any output apparatus such as a display, a projection apparatus, a printer, or a mailer.

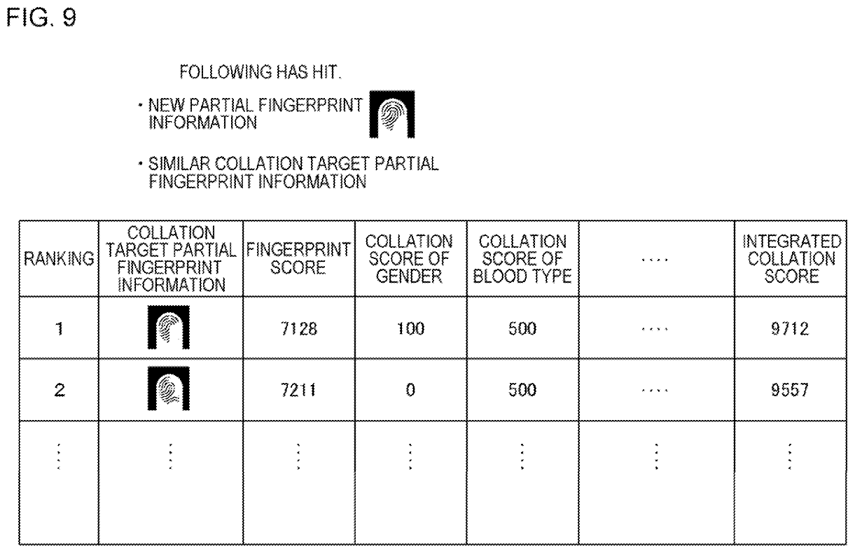

For example, a screen as illustrated in FIG. 9 may be displayed. In an illustrated example, a pair in which an integrated collation score is equal to or more than the second reference value is indicated, and also a fingerprint score, a collation score for each item included in attribute information, and an integrated collation score are indicated for each pair. An attribute score may be displayed, in place of or in addition to a collation score for each item included in attribute information. Note that, as illustrated in FIG. 9, in a case where a plurality of pairs in which an integrated collation score is equal to or more than the second reference value are present, ranking according to the integrated collation score may be performed, and the pairs may be displayed in order of ranking. An operator can determine whether new partial fingerprint information and collation target partial fingerprint information are to be combined or the like, based on a notification content.

In S27, the fingerprint information processing apparatus 10 notifies an operator of that collation target partial fingerprint information similar to new partial fingerprint information is not present. Notification to an operator may be achieved via any output apparatus such as a display, a projection apparatus, a printer, or a mailer.

### Second Processing Example

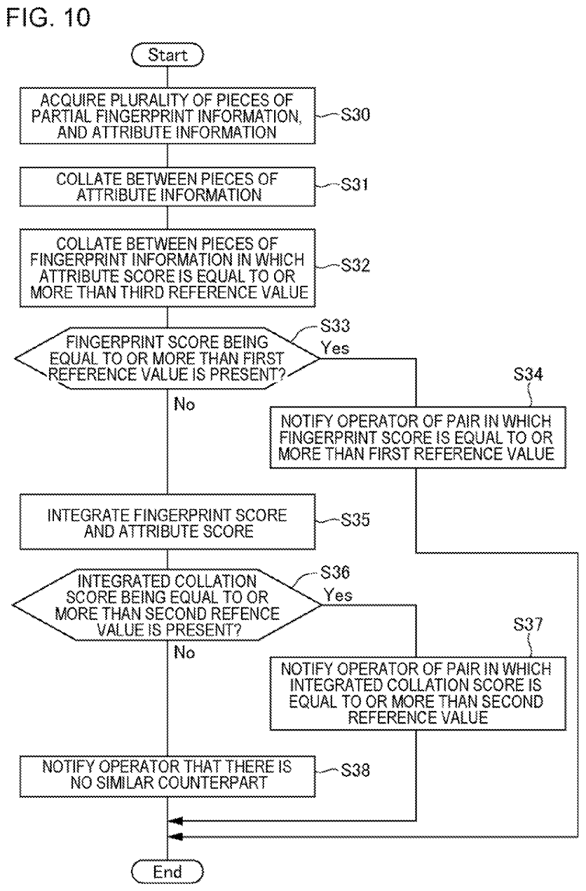

The second processing example is described by using a flowchart in FIG. 10. In the first processing example, all pieces of LLI target information stored in the storage unit 13 are set as a target to be collated with new partial fingerprint information. In the example, first, collation between pieces of attribute information is performed, then a target to be collated with new partial fingerprint information is narrowed down, based on the collation result, and thereby a processing load on a computer is reduced.

In S30, the acquisition unit 11 acquires a plurality of pieces of partial fingerprint information and attribute information. First, new partial fingerprint information and new attribute information newly collected in association with a new incident are input to the fingerprint information processing apparatus 10. For example, an operator may input new partial fingerprint information and new attribute information to the fingerprint information processing apparatus 10. In addition, an external apparatus different from the fingerprint information processing apparatus 10 may input, to the fingerprint information processing apparatus 10, new partial fingerprint information and new attribute information stored in a storage apparatus accessible from the external apparatus, based on an operator's operation, or according to an instruction of a predetermined program. The acquisition unit 11 acquires the input new partial fingerprint information and the input new attribute information. Further, the acquisition unit 11 acquires, in order from among pieces of LLI target information stored in the storage unit 13, collation target partial fingerprint information and collation target attribute information to be collated with the above-described new partial fingerprint information and the above-described new attribute information.

In S31, the information generation unit 12 collates the new attribute information acquired in S30 with collation target attribute information, and computes an attribute score.

The fingerprint information processing apparatus 10 repeats the above-described processing until all pieces of LLI target information are selected as collation target attribute information, and an attribute score is computed for each pair of all pieces of collation target attribute information and new attribute information. Then, after an attribute score is computed for each pair of all pieces of collation target attribute information and new attribute information, the processing proceeds to S32.

In S32, the acquisition unit 11 collates each of pieces of collation target partial fingerprint information associated with collation target attribute information in which the above-described attribute score becomes equal to or more than a third reference value with new partial fingerprint information, and computes a collation score. Collation target partial fingerprint information associated with collation target attribute information in which the above-described attribute score becomes less than the third reference value is eliminated from a target to be collated with new partial fingerprint information. The third reference value is a threshold value for determining whether collation between pieces of partial fingerprint information is to be performed.

Processing after P33 is similar to processing after S22 in the first processing example.

### Third Processing Example

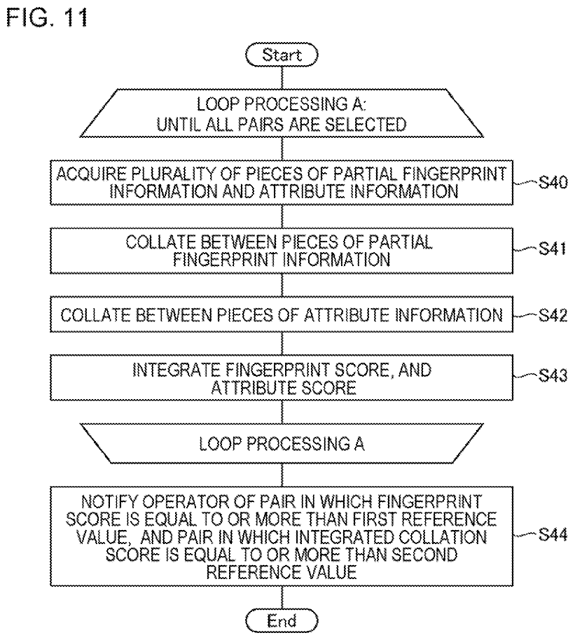

The third processing example is described by using a flowchart in FIG. 11. In the first and second processing examples, only a pair in which a fingerprint score is equal to or more than the first reference value is output (S23, S34), only a pair in which an integrated collation score is equal to or more than the second reference value is output (S26, S37), or only a matter that there is no similar counterpart is output (S27, S38). In contrast, in the example, a collation result on all pairs is output.

In S40, the acquisition unit 11 acquires a plurality of pieces of partial fingerprint information and attribute information. First, new partial fingerprint information and new attribute information newly collected in association with a new incident are input to the fingerprint information processing apparatus 10. For example, an operator may input new partial fingerprint information and new attribute information to the fingerprint information processing apparatus 10. In addition, an external apparatus different from the fingerprint information processing apparatus 10 may input, to the fingerprint information processing apparatus 10, new partial fingerprint information and new attribute information stored in a storage apparatus accessible from the external apparatus, based on an operator's operation, or according to an instruction of a predetermined program. The acquisition unit 11 acquires the input new partial fingerprint information and the input new attribute information. Further, the acquisition unit 11 acquires, from among pieces of LLI target information stored in the storage unit 13, collation target partial fingerprint information and collation target attribute information to be collated with the above-described new partial fingerprint information and the above-described new attribute information.

In S41, the information generation unit 12 collates the new partial fingerprint information acquired in S40 with collation target partial fingerprint information, and computes a fingerprint score. In S42, the information generation unit 12 collates the new attribute information acquired in S40 with collation target attribute information, and computes an attribute score. Note that, the processing order of S41 and S42 is not limited to the illustrated example. S42 may be performed first, or S41 and S42 may be performed concurrently.

In S43, the information generation unit 12 integrates the fingerprint score computed in S41 and the attribute score computed in S42, and computes an integrated collation score.

The fingerprint information processing apparatus 10 repeats the above-described processing until processing within loop processing A is performed for a pair of all pieces of LLI target information, and new partial fingerprint information and new attribute information. Then, after processing within the loop processing A is performed for a pair of all pieces of LLI target information, and new partial fingerprint information and new attribute information, the processing breaks out from the loop processing A, and proceeds to S44.

In S44, the fingerprint information processing apparatus 10 notifies an operator of a pair in which a fingerprint score is equal to or more than the first reference value, and a pair in which an integrated collation score is equal to or more than the second reference value. One of the pair is new partial fingerprint information, and the other of the pair is collation target partial fingerprint information. Notification to an operator is achieved via any output apparatus such as a display, a projection apparatus, a printer, or a mailer. An operator can determine whether a pair of the pieces of partial fingerprint information is to be combined or the like, based on a notification content.

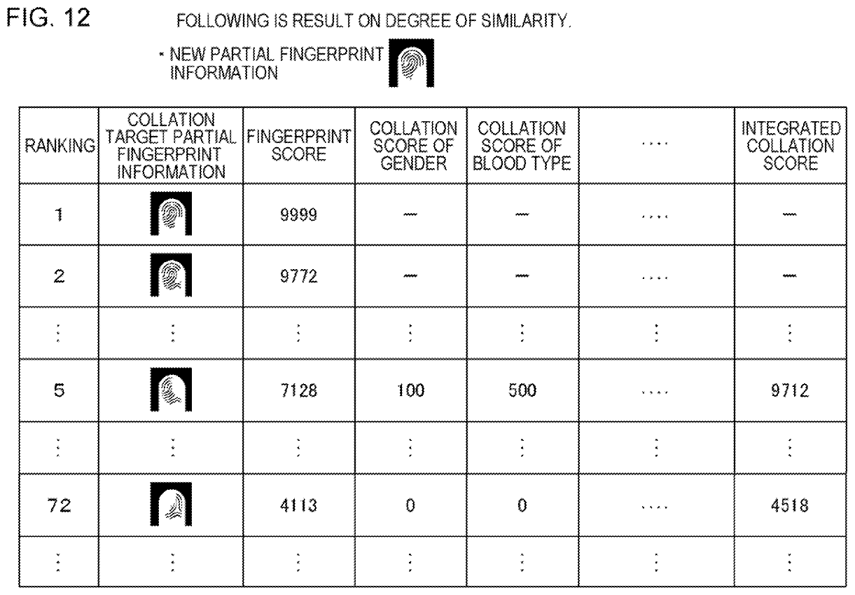

For example, a screen as illustrated in FIG. 12 may be displayed. In an illustrated example, all pairs are displayed as a list, and also a fingerprint score, a collation score for each item included in attribute information, and an integrated collation score are indicated for each pair. An attribute score may be displayed, in place of or in addition to a collation score for each item included in attribute information. Note that, as illustrated in FIG. 12, a plurality of pairs may be displayed by ranking. In the example illustrated in FIG. 10, after a pair in which a fingerprint score is equal to or more than the first reference value is ranked in order of a fingerprint score, and then, a pair in which a fingerprint score is less than the first reference value is ranked in order of an integrated collation score at a position below the ranking. Further, in the list display, a pair in which a fingerprint score is equal to or more than the first reference value, and a pair in which an integrated collation score is equal to or more than the second reference value may be displayed in a distinguishable manner. An operator can determine whether new partial fingerprint information and collation target partial fingerprint information are to be combined or the like, based on a notification content.

### Fourth Processing Example

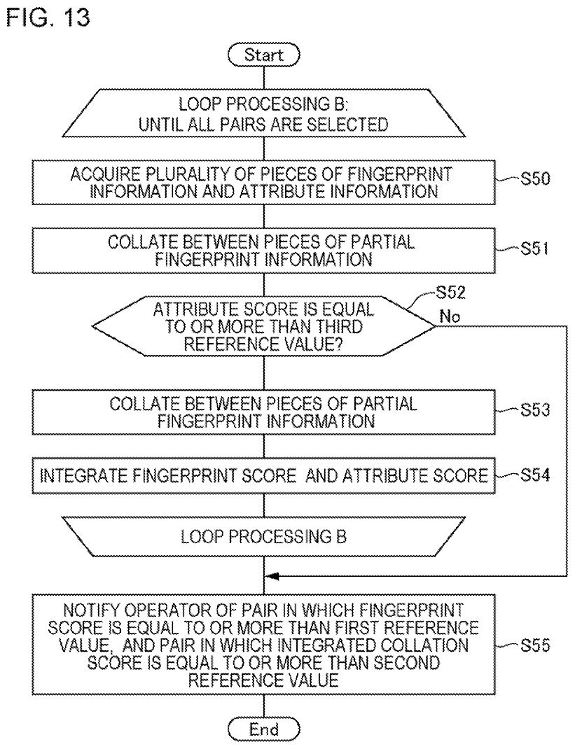

The fourth processing example is described by using a flowchart in FIG. 13. In the third processing example, all pieces of LLI target information stored in the storage unit 13 are set as a target to be collated with new partial fingerprint information. In the example, first, collation between pieces of attribute information is performed, then a target to be collated with new partial fingerprint information is narrowed down, based on the collation result, and thereby a processing load on a computer is reduced.

In S50, the acquisition unit 11 acquires a plurality of pieces of partial fingerprint information and attribute information. First, new partial fingerprint information and new attribute information newly collected in association with a new incident are input to the fingerprint information processing apparatus 10. For example, an operator may input new partial fingerprint information and new attribute information to the fingerprint information processing apparatus 10. In addition, an external apparatus different from the fingerprint information processing apparatus 10 may input, to the fingerprint information processing apparatus 10, new partial fingerprint information and new attribute information stored in a storage apparatus accessible from the external apparatus, based on an operator's operation, or according to an instruction of a predetermined program. The acquisition unit 11 acquires the input new partial fingerprint information and the input new attribute information. Further, the acquisition unit 11 acquires, from among pieces of LLI target information stored in the storage unit 13, collation target partial fingerprint information and collation target attribute information to be collated with the above-described new partial fingerprint information and the above-described new attribute information.

In S51, the information generation unit 12 collates the new attribute information acquired in S50 with collation target attribute information, and computes an attribute score.

In S52, it is determined whether the attribute score computed in S51 is equal to or more than the third reference value. In a case where the attribute score computed in S51 is equal to or more than the third reference value, the processing proceeds to S53. In a case where the attribute score computed in S51 is less than the third reference value, the processing proceeds to determination as to whether loop processing B is to be finished, without performing S53 and S54.

In S53, the information generation unit 12 collates the new partial fingerprint information acquired in S50 with collation target partial fingerprint information, and computes a fingerprint score.

In S54, the information generation unit 12 integrates the attribute score computed in S51 and the fingerprint score computed in S53, and computes an integrated collation score.

The fingerprint information processing apparatus 10 repeats the above-described processing until processing within loop processing B is performed for a pair of all pieces of LLI target information, and new partial fingerprint information and new attribute information. Then, after processing within the loop processing B is performed for a pair of all pieces of LLI target information, and new partial fingerprint information and new attribute information, the processing breaks out from the loop processing B, and proceeds to S55.

Processing of S55 is similar to processing of S44 of the third processing example.

### Fifth Processing Example

A flow of processing of the fifth processing example is illustrated by the flowchart in FIG. 7 similarly to the first processing example. The fifth processing example is different from the first processing example in a way of acquisition of a plurality of pieces of partial fingerprint information and a plurality of pieces of attribute information by the acquisition unit 11 in S20.

In the first processing example, the fingerprint information processing apparatus 10 performs computation of a fingerprint score, an attribute score, an integrated collation score, and the like for each pair of “new partial fingerprint information and new attribute information” newly collated in association with a new incident, and “collation target partial fingerprint information and collation target attribute information” acquired from among pieces of LLI target information stored in the storage unit 13.

In the fifth processing example, the acquisition unit 11 acquires, from among pieces of LLI target information stored in the storage unit 13, partial fingerprint information and attribute information of a first processing target, and partial fingerprint information and attribute information of a second processing target. Then, the information generation unit 12 performs computation of a fingerprint score, an attribute score, an integrated collation score, and the like for each pair being extracted and generated from among pieces of LLI target information stored in the storage unit 13.

Other configurations of the fifth processing example can be assumed to be according to the first processing example.

### Sixth Processing Example

A flow of processing of the sixth processing example is illustrated by the flowchart in FIG. 10 similarly to the second processing example. The sixth processing example is different from the second processing example in a way of acquisition of a plurality of pieces of partial fingerprint information and a plurality of pieces of attribute information by the acquisition unit 11 in S30.

In the second processing example, the fingerprint information processing apparatus 10 performs computation of a fingerprint score, an attribute score, an integrated collation score, and the like for each pair of “new partial fingerprint information and new attribute information” newly collated in association with a new incident, and “collation target partial fingerprint information and collation target attribute information” acquired from among pieces of LLI target information stored in the storage unit 13.

In the sixth processing example, the acquisition unit 11 acquires, from among pieces of LLI target information stored in the storage unit 13, partial fingerprint information and attribute information of a first processing target, and partial fingerprint information and attribute information of a second processing target. Then, the information generation unit 12 performs computation of a fingerprint score, an attribute score, an integrated collation score, and the like for each pair being extracted and generated from among pieces of LLI target information stored in the storage unit 13.

Other configurations of the sixth processing example can be assumed to be according to the second processing example.

### Seventh Processing Example

A flow of processing of the seventh processing example is illustrated by the flowchart in FIG. 11 similarly to the third processing example. The seventh processing example is different from the third processing example in a way of acquisition of a plurality of pieces of partial fingerprint information and a plurality of pieces of attribute information by the acquisition unit 11 in S40.

In the third processing example, the fingerprint information processing apparatus 10 performs computation of a fingerprint score, an attribute score, an integrated collation score, and the like for each pair of “new partial fingerprint information and new attribute information” newly collated in association with a new incident, and “collation target partial fingerprint information and collation target attribute information” acquired from among pieces of LLI target information stored in the storage unit 13.

In the seventh processing example, the acquisition unit 11 acquires, from among pieces of LLI target information stored in the storage unit 13, partial fingerprint information and attribute information of a first processing target, and partial fingerprint information and attribute information of a second processing target. Then, the information generation unit 12 performs computation of a fingerprint score, an attribute score, an integrated collation score, and the like for each pair being extracted and generated from among pieces of LLI target information stored in the storage unit 13.

Other configurations of the seventh processing example can be assumed to be according to the third processing example.

### Eighth Processing Example

A flow of processing of the eighth processing example is illustrated by the flowchart in FIG. 13 similarly to the fourth processing example. The eighth processing example is different from the fourth processing example in a way of acquisition of a plurality of pieces of partial fingerprint information and a plurality of pieces of attribute information by the acquisition unit 11 in S50.

In the fourth processing example, the fingerprint information processing apparatus 10 performs computation of a fingerprint score, an attribute score, an integrated collation score, and the like for each pair of “new partial fingerprint information and new attribute information” newly collated in association with a new incident, and “collation target partial fingerprint information and collation target attribute information” acquired from among pieces of LLI target information stored in the storage unit 13.

In the eighth processing example, the acquisition unit 11 acquires, from among pieces of LLI target information stored in the storage unit 13, partial fingerprint information and attribute information of a first processing target, and partial fingerprint information and attribute information of a second processing target. Then, the information generation unit 12 performs computation of a fingerprint score, an attribute score, an integrated collation score, and the like for each pair being extracted and generated from among pieces of LLI target information stored in the storage unit 13.

Other configurations of the eighth processing example can be assumed to be according to the fourth processing example.

Other configurations of the fingerprint information processing apparatus 10 according to the present example embodiment are similar to those of the first example embodiment.

In the fingerprint information processing apparatus 10 according to the present example embodiment described above, an advantageous effect similar to that of the first example embodiment is achieved. Further, in the fingerprint information processing apparatus 10 according to the present example embodiment, it is possible to compute a fingerprint score indicating a degree of similarity between a plurality of pieces of partial fingerprint information, an attribute score indicating a degree of similarity between a plurality of pieces of attribute information, and an integrated collation score in which the fingerprint score and the attribute score are integrated. Then, the fingerprint information processing apparatus can generate and output the first information indicating a likelihood that a plurality of pieces of partial fingerprint information are derived from a same person, based on these computation results. The first information includes a fingerprint score and an integrated collation score. An operator can easily recognize a likelihood that a plurality of pieces of partial fingerprint information are derived from a same person, based on the first information digitized as described above.

Further, as described by using the flowcharts in FIGS. 10 and 13, the fingerprint information processing apparatus 10 can narrow down a target for which a fingerprint score and an integrated collation score are computed, based on an attribute score indicating a degree of similarity between pieces of attribute information. Consequently, it is possible to reduce a processing load on a computer.

### Third Example Embodiment

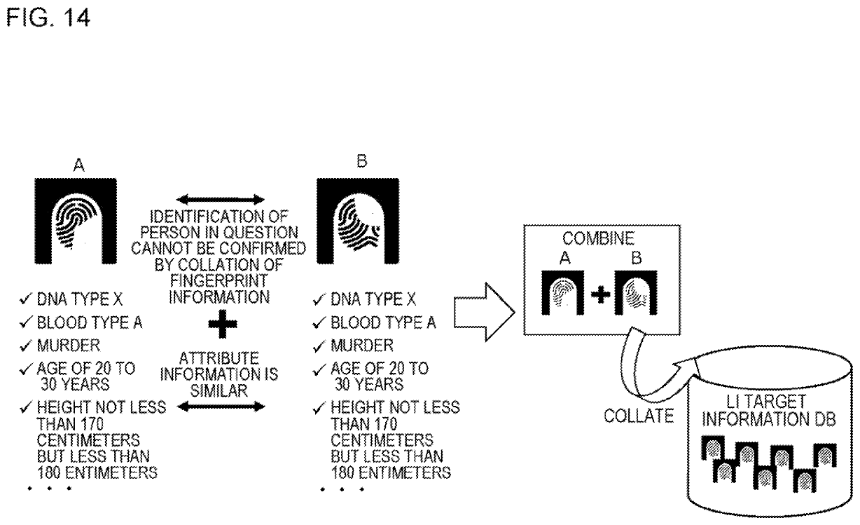

As illustrated in FIG. 14, a fingerprint information processing apparatus 10 according to a present example embodiment includes a function of combining a plurality of pieces of partial fingerprint information, and performing LI by using combined fingerprint information. The fingerprint information processing apparatus 10 according to the present example embodiment determines a plurality of pieces of partial fingerprint information to be combined, based on an operator's input.

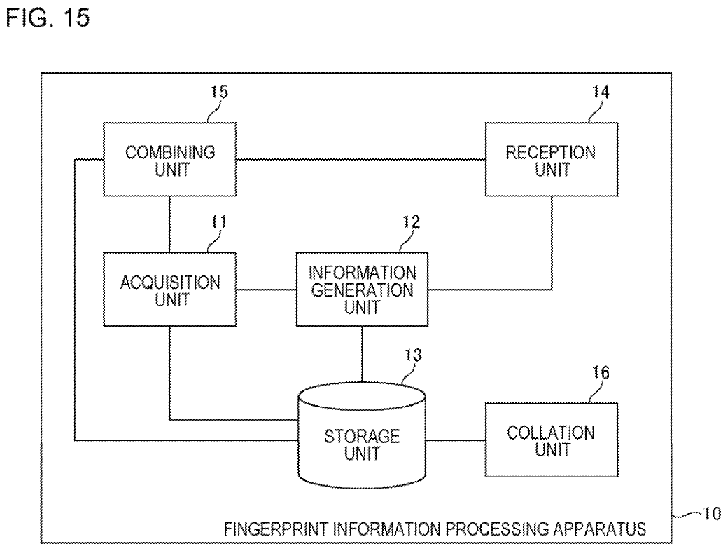

FIG. 15 illustrates one example of a functional block diagram of the fingerprint information processing apparatus 10 according to the present example embodiment. As illustrated in FIG. 15, the fingerprint information processing apparatus 10 according to the present example embodiment is different from the fingerprint information processing apparatus 10 according to the first and second example embodiments in a point that a reception unit 14, a combining unit 15, and a collation unit 16 are included.

The reception unit 14 outputs a plurality of pieces of partial fingerprint information, and first information generated in association with the plurality of pieces of partial fingerprint information toward an operator. For example, the reception unit 14 can output a screen as illustrated in FIGS. 8, 9, and 12 toward an operator.

Then, after the above-described output, the reception unit 14 receives an input of combining a plurality of pieces of partial fingerprint information from an operator. The operator confirms information output from the reception unit 14, for example, a screen as illustrated in FIGS. 8, 9, and 12, and determines a pair in which partial fingerprint information is conceived to be derived from a same person. Then, the operator specifies the determined pair, and inputs an instruction of combining these pieces of partial fingerprint information. Input by the operator is achieved via any input apparatus such as a keyboard, a mouse, a touch panel, a microphone, or a physical button.

The combining unit 15 combines a plurality of pieces of partial fingerprint information whose input of combination is received, and generates combined fingerprint information. Combination of partial fingerprint information is achieved based on any existing technique. For example, a technique disclosed in Patent Document 1 may be utilized. In addition, the combining unit 15 may provide a means that combines a plurality of pieces of partial fingerprint information, based on an operator's input. For example, the combining unit 15 may display, on a display, an image on a plurality of partial fingerprints, and also receive an input of enlarging/reducing an image on each partial fingerprint, an input of moving an image on each partial fingerprint within a screen, an input of rotating an image on each partial fingerprint, and the like. Then, the combining unit 15 may combine images on a plurality of partial fingerprints in a state specified by an operator through the above-described input.

The collation unit 16 collates combined fingerprint information generated by the combining unit 15 with fingerprint information registered in a storage unit 13. Then, the collation unit 16 outputs a collation result. An output of a collation result is achieved via any output apparatus such as a display, a projection apparatus, a printer, or a mailer.

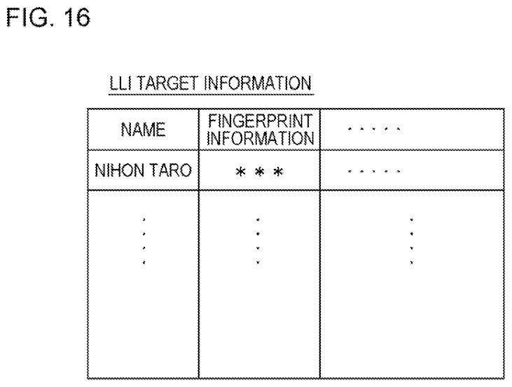

Collation by the collation unit 16 is collation for the above-described LI. Specifically, fingerprint information to be collated with combined fingerprint information is LI target information as illustrated in FIG. 16. LI target information includes fingerprint information whose identity is known. Fingerprint information whose identity is known is complete fingerprint information. Collation processing by the collation unit 16 is achieved based on any existing technique.

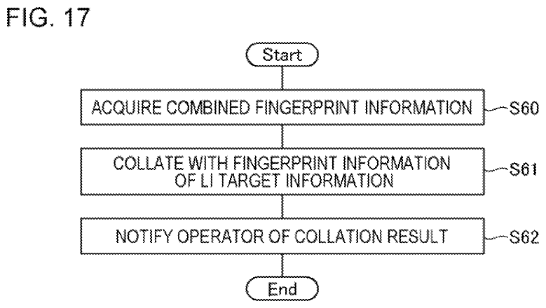

Next, one example of a flow of processing of the fingerprint information processing apparatus 10 is described by using a flowchart in FIG. 17.

In S60, the fingerprint information processing apparatus 10 acquires combined fingerprint information. Specifically, the reception unit 14 outputs a plurality of pieces of partial fingerprint information and the first information toward an operator, and after the output, receives, from an operator, an input of combining the plurality of pieces of partial fingerprint information. Thereafter, the combining unit 15 combines the plurality of pieces of partial fingerprint information whose input of combination is received, and generates combined fingerprint information.

In S61, the collation unit 16 collates the combined fingerprint information acquired in S60 with fingerprint information of LI target information stored in the storage unit 13.

In S62, the collation unit 16 outputs a collation result in S61. For example, in a case where LI target information in which a degree of similarity to combined fingerprint information is equal to or more than a fourth reference value is found, the collation unit 16 can notify an operator of the search result. The fourth reference value is a threshold value for determining whether pieces of fingerprint information mutually collated are derived from a same person. A content to be notified can include a name of a person or the like derived from LI target information in which a degree of similarity to combined fingerprint information is equal to or more than the fourth reference value. On the other hand, in a case where LI target information in which a degree of similarity to combined fingerprint information is equal to or more than the fourth reference value is not found, the collation unit 16 can notify an operator to the effect.

Other configurations of the fingerprint information processing apparatus 10 according to the present example embodiment are similar to those of the first and second example embodiments.

In the fingerprint information processing apparatus 10 according to the present example embodiment described above, an advantageous effect similar to that of the first and second example embodiments is achieved. Further, in the fingerprint information processing apparatus 10 according to the present example embodiment, it is possible to not only generate the first information indicating a likelihood that a plurality of pieces of partial fingerprint information are derived from a same person, but also output the first information toward an operator, and generate combined fingerprint information by combining the plurality of pieces of partial fingerprint information, based on an operator's input. Further, in the fingerprint information processing apparatus 10 according to the present example embodiment, it is possible to perform LI by using combined fingerprint information. In the fingerprint information processing apparatus 10 according to the present example embodiment as described above, convenience is improved.

### Fourth Example Embodiment

A fingerprint information processing apparatus 10 according to a present example embodiment includes a function of determining whether a plurality of pieces of partial fingerprint information are to be combined, based on first information, combining partial fingerprint information being determined to be combined, and performing LI by using combined fingerprint information.

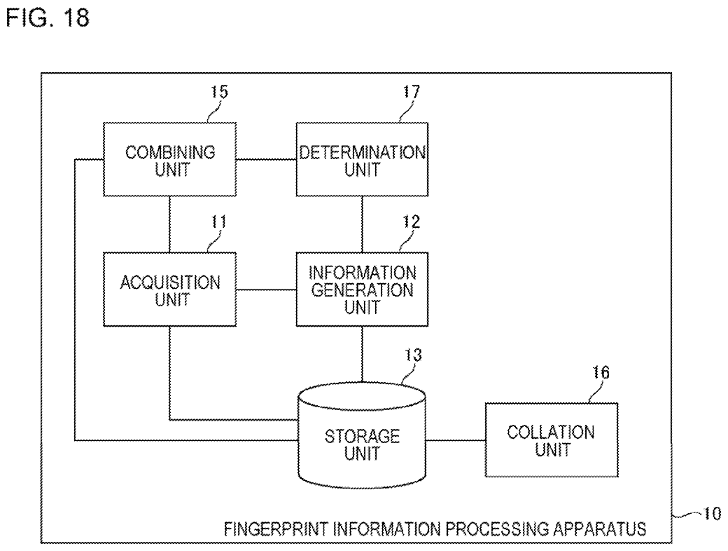

FIG. 18 illustrates one example of a functional block diagram of the fingerprint information processing apparatus 10 according to the present example embodiment. As illustrated in FIG. 18, the fingerprint information processing apparatus 10 according to the present example embodiment is different from the fingerprint information processing apparatus 10 according to the first and second example embodiments in a point that a combining unit 15, a collation unit 16, and a determination unit 17 are included.

The determination unit 17 determines whether a plurality of pieces of partial fingerprint information to be combined, based on the first information. The determination unit 17 determines that a plurality of pieces of partial fingerprint information in which the first information satisfies a predetermined condition are to be combined. The predetermined condition is, for example, “a fingerprint score is equal to or more than a first reference value”, or “an integrated collation score is equal to or more than a second reference value”.

The combining unit 15 combines a plurality of pieces of partial fingerprint information in which the first information satisfies the predetermined condition. Other configurations of the combining unit 15 are as described in the third example embodiment.

A configuration of the collation unit 16 is as described in the third example embodiment.

Other configurations of the fingerprint information processing apparatus 10 according to the present example embodiment are similar to those of the first to third example embodiments.

In the fingerprint information processing apparatus 10 according to the present example embodiment described above, an advantageous effect similar to that of the first to third example embodiments is achieved. Further, in the fingerprint information processing apparatus 10 according to the present example embodiment, it is possible to determine pieces of partial fingerprint information to be combined with each other. This enables to reduce work of an operator.

### Example

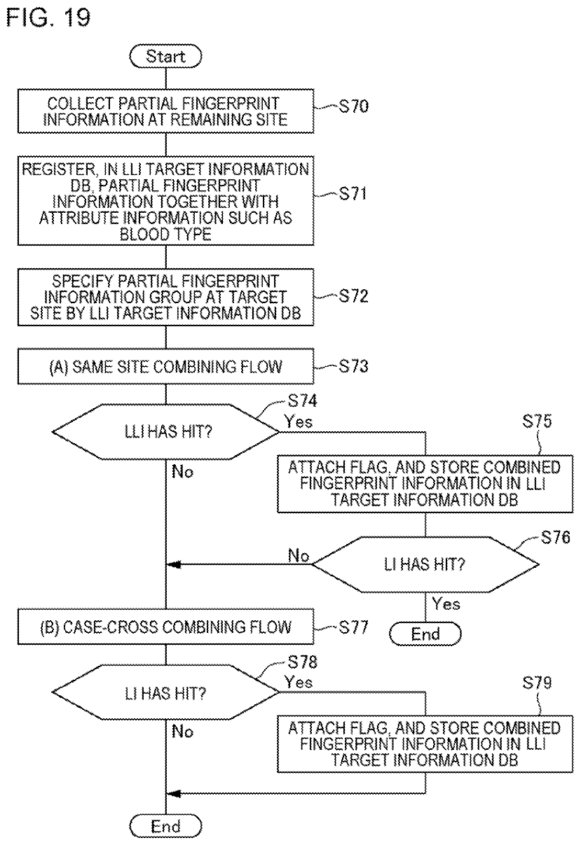

Next, one example of a flow of processing of work utilizing a fingerprint information processing apparatus 10 is described by using flowcharts in FIGS. 19 to 21.

In S70 in FIG. 19, fingerprint information is collected at a remaining site. Note that, since a major part of fingerprint information collected at a remaining site is partial fingerprint information, herein, it is assumed that partial fingerprint information is collected. Further, in S70, attribute information of a person from whom the partial fingerprint information is derived is acquired. Acquisition of attribute information is achieved by an inspection at an incident site by a worker, collection of eyewitness testimony, an analysis of a surveillance camera image by a computer, and the like.

In S71, an operator registers, in the fingerprint information processing apparatus 10, the partial fingerprint information and the attribute information acquired in S70, as LLI target information. The registered information is stored in a storage unit 13. One example of LLI target information stored in the storage unit 13 is illustrated in FIG. 5.

In S72, a partial fingerprint information group to be processed is specified from among pieces of LLI target information stored in the storage unit 13. For example, an operator specifies, on a predetermined UI screen, a fingerprint information group at a current remaining site.

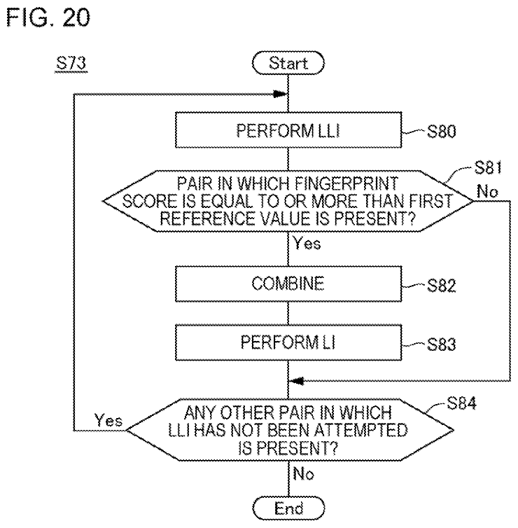

In S73, the fingerprint information processing apparatus 10 performs (A) same site combining flow. The flow is a flow of collating between a plurality of pieces of partial fingerprint information and combining the plurality of pieces of partial fingerprint information with each other, based on a fingerprint score, and thereafter, performing LI. FIG. 20 illustrates details on the (A) same site combining flow.

In S80, the fingerprint information processing apparatus 10 performs LLI. Specifically, the fingerprint information processing apparatus 10 collates between pieces of partial fingerprint information specified in S72.

In S81, the fingerprint information processing apparatus 10 determines whether a pair in which a fingerprint score is equal to or more than a first reference value is present. In a case where a pair in which a fingerprint score is equal to or more than the first reference value is present (Yes in S81), the processing proceeds to S82. In a case where a pair in which a fingerprint score is equal to or more than the first reference value is not present (No in S81), the processing proceeds to S84.

In S82, the fingerprint information processing apparatus 10 combines a pair in which a fingerprint score is equal to or more than the first reference value. In S82, the fingerprint information processing apparatus 10 can perform, for example, processing described in the third example embodiment, or processing described in the fourth example embodiment.

In S83, the fingerprint information processing apparatus 10 performs LI. Specifically, the fingerprint information processing apparatus 10 collates the combined fingerprint information generated in S82 with LI target fingerprint information stored in the storage unit 13. One example of LI target information stored in the storage unit 13 is illustrated in FIG. 16.

In S84, the fingerprint information processing apparatus 10 determines whether a pair for which LI in S80 has not been performed is present. In a case where a pair for which LI in S80 has not been performed is present (Yes in S80), the fingerprint information processing apparatus 10 returns to S80, and repeats similar processing. In a case where a pair for which LI in S80 has not been performed is not present (No in S84), the fingerprint information processing apparatus 10 finishes the (A) same site combining flow.

Referring back to FIG. 19, in S74 after S73, the fingerprint information processing apparatus 10 determines whether LLI has hit by the (A) same site combining flow. “LLI has hit” means that presence of a pair in which a fingerprint score is equal to or more than the first reference value has been detected. In a case where LLI has hit by the (A) same site combining flow (Yes in S74), the processing proceeds to S75. In a case where LLI has not hit by the (A) same site combining flow (No in S74), the processing proceeds to S77.

In S75, the fingerprint information processing apparatus 10 attaches a flag, and stores, in the storage unit 13, the combined fingerprint information generated by the (A) same site combining flow, as LLI target information.

In S76, the fingerprint information processing apparatus 10 determines whether LI has hit by the (A) same site combining flow. “LI has hit” means that presence of LI target information in which a collation score with the combined fingerprint information generated by the (A) same site combining flow is equal to or more than a fourth reference value has been detected. In a case where LI has hit by the (A) same site combining flow (Yes in S76), the processing is finished. In a case where LI has not hit by the (A) same site combining flow (No in S76), the processing proceeds to S77.

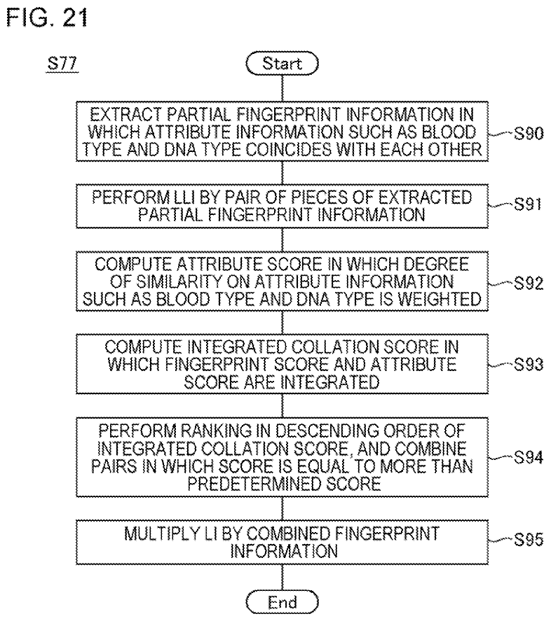

In S77, the fingerprint information processing apparatus 10 performs (B) case-cross combining flow. The flow is a flow of combining a plurality of pieces of partial fingerprint information with each other, based on an integrated collation score, and thereafter, performing LI. FIG. 21 illustrates details on the (B) case-cross combining flow.

In 590, the fingerprint information processing apparatus 10 extracts a partial fingerprint information group in which predetermined attribute information such as a blood type and a DNA type coincides with each other.

In S91, the fingerprint information processing apparatus 10 generates a pair of pieces of partial fingerprint information by the partial fingerprint information extracted in 590. Then, the fingerprint information processing apparatus 10 collates between pieces of partial fingerprint information for each pair, and computes a fingerprint score.

In S92, the fingerprint information processing apparatus 10 collates between pieces of attribute information for the each pair, and computes an attribute score being a collation score of attribute information.

In 593, the fingerprint information processing apparatus 10 integrates the fingerprint score computed in S91 and the attribute score computed in S92 for the each pair, and computes an integrated collation score.

In S94, the fingerprint information processing apparatus 10 performs ranking of the above-described pairs in descending order of the integrated collation score, and extracts a pair having a predetermined score or more. Then, the fingerprint information processing apparatus 10 combines pieces of partial fingerprint information of the extracted pair with each other, and generates combined fingerprint information.

In 595, the fingerprint information processing apparatus 10 performs LI. Specifically, the fingerprint information processing apparatus 10 collates the combined fingerprint information generated in S94 with LI target fingerprint information stored in the storage unit 13. One example of LI target information stored in the storage unit 13 is illustrated in FIG. 16.

Referring back to FIG. 19, in S78 after S77, the fingerprint information processing apparatus 10 determines whether LI has hit by the (B) case-cross combining flow. “LI has hit” means that presence of LI target information in which a collation score with combined fingerprint information generated by the (B) case-cross combining flow is equal to or more than the fourth reference value has been detected. In a case where LI has hit by the (B) case-cross combining flow (Yes in S78), the processing proceeds to S79. In a case where LI has not hit by the (B) case-cross combining flow (No in S78), the processing is finished.

In S79, the fingerprint information processing apparatus 10 attaches a flag, and stores, in the storage unit 13, the combined fingerprint information generated by the (B) case-cross combining flow, as LLI target information.

In the foregoing, example embodiments according to the present invention have been described with reference to the drawings, however, these are examples of the present invention, and various configurations other than the above can also be adopted.

Note that, in the present specification, “acquisition” includes at least one of “fetching data stored in another apparatus or a storage medium by an own apparatus (active acquisition)”, based on a user input, or based on an instruction of a program, for example, requesting or inquiring another apparatus and then receiving, accessing another apparatus or a storage medium and then reading, and the like, “inputting data being output from another apparatus to an own apparatus (passive acquisition)”, based on a user input, or based on an instruction of a program, for example, receiving data being distributed (or transmitted, push notified, or the like), or selecting and acquiring from data or information being received, and “generating new data by editing data (text conversion, data rearrangement, extraction of partial data, change in a file format, and the like) or the like, and acquiring the generated new data”.

Apart or all of the above-described example embodiments may also be described as the following supplementary notes, but is not limited to the following.

1. A fingerprint information processing apparatus including:
an acquisition unit that acquires a plurality of pieces of partial fingerprint information, and attribute information of a person from whom each of a plurality of pieces of the partial fingerprint information is derived; and
an information generation unit that generates first information indicating a likelihood that a plurality of pieces of the partial fingerprint information are derived from a same person, by using the partial fingerprint information and the attribute information.
   2. The fingerprint information processing apparatus according to supplementary note 1, wherein
the attribute information indicates at least one of a physical feature and a behavioral feature.
   3. The fingerprint information processing apparatus according to supplementary note 1 or 2, wherein
the attribute information indicates at least one of information relating to a place where the partial fingerprint information is collected, information detected at a place where the partial fingerprint information is collected, and information relating to an incident where the partial fingerprint information is collected.
   4. The fingerprint information processing apparatus according to any of supplementary notes 1 to 3, wherein
the attribute information indicates at least one of a blood type, a DNA type, gender, an age group, and a height.
   5. The fingerprint information processing apparatus according to any of supplementary notes 1 to 4, wherein
the information generation unit
   computes a fingerprint score indicating a degree of similarity between a plurality of pieces of the partial fingerprint information, and an attribute score indicating a degree of similarity between a plurality of pieces of the attribute information, and generates the first information, based on the fingerprint score and the attribute score.
      6. The fingerprint information processing apparatus according to any of supplementary notes 1 to 5, further including:
a reception unit that outputs a plurality of pieces of the partial fingerprint information, and the first information toward an operator, and after the output, receives an input of combining a plurality of pieces of the partial fingerprint information from an operator; and
a combining unit that combines a plurality of pieces of the partial fingerprint information that receives an input of combination, and generates combined fingerprint information.
   7. The fingerprint information processing apparatus according to any of supplementary notes 1 to 5, further including
a combining unit that combines a plurality of pieces of partial fingerprint information in which the first information satisfies a predetermined condition, and generates combined fingerprint information.
   8. The fingerprint information processing apparatus according to supplementary note 6 or 7, further including
a collation unit that collates the combined fingerprint information with fingerprint information registered in a storage unit.
   9. A fingerprint information processing method including,
by a computer:
   an acquisition step of acquiring a plurality of pieces of partial fingerprint information, and attribute information of a person from whom each of a plurality of pieces of the partial fingerprint information is derived; and
   an information generation step of generating first information indicating a likelihood that a plurality of pieces of the partial fingerprint information are derived from a same person, by using the partial fingerprint information and the attribute information.
      10. A program causing a computer to function as:
an acquisition unit that acquires a plurality of pieces of partial fingerprint information, and attribute information of a person from whom each of a plurality of pieces of the partial fingerprint information is derived; and
an information generation unit that generates first information indicating a likelihood that a plurality of pieces of the partial fingerprint information are derived from a same person, by using the partial fingerprint information and the attribute information.

### REFERENCE SIGNS LIST

10 Fingerprint information processing apparatus
11 Acquisition unit
12 Information generation unit
13 Storage unit
14 Reception unit
15 Combining unit
16 Collation unit
17 Determination unit
1A Processor
2A Memory
3A Input/output I/F
4A Peripheral circuit
5A Bus

What is claimed is:

1. A fingerprint information processing apparatus comprising:
at least one memory configured to store one or more instructions; and
at least one processor configured to execute the one or more instructions to:
acquire a plurality of pieces of partial fingerprint information, and attribute information of a person from whom each of a plurality of pieces of the partial fingerprint information is derived; and
generate first information indicating a likelihood that a plurality of pieces of the partial fingerprint information are derived from a same person, by using the partial fingerprint information and the attribute information.

2. The fingerprint information processing apparatus according to claim 1, wherein
the attribute information indicates at least one of a physical feature and a behavioral feature.

3. The fingerprint information processing apparatus according to claim 1, wherein
the attribute information indicates at least one of information relating to a place where the partial fingerprint information is collected, information detected at a place where the partial fingerprint information is collected, and information relating to an incident where the partial fingerprint information is collected.

4. The fingerprint information processing apparatus according to claim 1, wherein
the attribute information indicates at least one of a blood type, a DNA type, gender, an age group, and a height.

5. The fingerprint information processing apparatus according to claim 1, wherein
the processor is further configured to execute the one or more instructions to
compute a fingerprint score indicating a degree of similarity between a plurality of pieces of the partial fingerprint information, and an attribute score indicating a degree of similarity between a plurality of pieces of the attribute information, and generate the first information, based on the fingerprint score and the attribute score.

6. The fingerprint information processing apparatus according to claim 1, wherein the processor is further configured to execute the one or more instructions to
output a plurality of pieces of the partial fingerprint information and the first information toward an operator, and after the output, receive an input of combining a plurality of pieces of the partial fingerprint information from an operator; and
combine a plurality of pieces of the partial fingerprint information that receives an input of combination, and generate combined fingerprint information.

7. The fingerprint information processing apparatus according to claim 1, wherein the processor is further configured to execute the one or more instructions to
combine a plurality of pieces of partial fingerprint information in which the first information satisfies a predetermined condition, and generate combined fingerprint information.

8. The fingerprint information processing apparatus according to claim 6, wherein the processor is further configured to execute the one or more instructions to
collate the combined fingerprint information with registered fingerprint information.

9. A fingerprint information processing method comprising,
by a computer:
acquiring a plurality of pieces of partial fingerprint information, and attribute information of a person from whom each of a plurality of pieces of the partial fingerprint information is derived; and
generating first information indicating a likelihood that a plurality of pieces of the partial fingerprint information are derived from a same person, by using the partial fingerprint information and the attribute information.

10. A non-transitory storage medium storing a program causing a computer to:
acquire a plurality of pieces of partial fingerprint information, and attribute information of a person from whom each of a plurality of pieces of the partial fingerprint information is derived; and
generate first information indicating a likelihood that a plurality of pieces of the partial fingerprint information are derived from a same person, by using the partial fingerprint information and the attribute information.

11. The fingerprint information processing method according to claim 9, wherein
the attribute information indicates at least one of a physical feature and a behavioral feature.

12. The fingerprint information processing method according to claim 9, wherein
the attribute information indicates at least one of information relating to a place where the partial fingerprint information is collected, information detected at a place where the partial fingerprint information is collected, and information relating to an incident where the partial fingerprint information is collected.

13. The fingerprint information processing method according to claim 9, wherein
the attribute information indicates at least one of a blood type, a DNA type, gender, an age group, and a height.

14. The fingerprint information processing method according to claim 9, wherein
the computer
computes a fingerprint score indicating a degree of similarity between a plurality of pieces of the partial fingerprint information, and an attribute score indicating a degree of similarity between a plurality of pieces of the attribute information, and generates the first information, based on the fingerprint score and the attribute score.

15. The fingerprint information processing method according to claim 9, wherein
the computer
outputs a plurality of pieces of the partial fingerprint information and the first information toward an operator, and after the output, receives an input of combining a plurality of pieces of the partial fingerprint information from an operator; and
combines a plurality of pieces of the partial fingerprint information that receives an input of combination, and generates combined fingerprint information.

16. The non-transitory storage medium according to claim 10, wherein
the attribute information indicates at least one of a physical feature and a behavioral feature.

17. The non-transitory storage medium according to claim 10, wherein
the attribute information indicates at least one of information relating to a place where the partial fingerprint information is collected, information detected at a place where the partial fingerprint information is collected, and information relating to an incident where the partial fingerprint information is collected.

18. The non-transitory storage medium according to claim 10, wherein
the attribute information indicates at least one of a blood type, a DNA type, gender, an age group, and a height.

19. The non-transitory storage medium according to claim 10, wherein the program causing the computer to
compute a fingerprint score indicating a degree of similarity between a plurality of pieces of the partial fingerprint information, and an attribute score indicating a degree of similarity between a plurality of pieces of the attribute information, and generate the first information, based on the fingerprint score and the attribute score.

20. The non-transitory storage medium according to claim 10, wherein the program causing the computer to
output a plurality of pieces of the partial fingerprint information and the first information toward an operator, and after the output, receive an input of combining a plurality of pieces of the partial fingerprint information from an operator; and
combine a plurality of pieces of the partial fingerprint information that receives an input of combination, and generate combined fingerprint information.
